(19) United States
(12) Patent Application Publication
(10) Pub. No.: US 2011/0042307 A1
(43) Pub. Date: Feb. 24, 2011

(54) METHODS AND APPARATUSES TO REDUCE HYDROGEN SULFIDE IN A BIOGAS

(75) Inventors: Douglas VanOrnum, Menasha, WI (US); Stephen W. Dvorak, Chilton, WI (US)

Correspondence Address: WHYTE HIRSCHBOECK DUDEK S.C.;INTELLECTUAL PROPERTY DEPARTMENT, 33 East Main Street, Suite 300, Madison, WI, 53703-4655, US

(73) Assignee: GHD, INC., Chilton, WI (US)

(21) Appl. No.: 12/765,301

(22) Filed: Apr. 22, 2010

Related U.S. Application Data
(60) Provisional application No. 61/214,429, filed on Apr. 23, 2009.

(51) Int. Cl. C02F 3/28

(52) U.S. Cl. 210/603; 210/137

(57) ABSTRACT

Apparatuses and methods for anaerobic digestion of high-solids waste and the removal of hydrogen sulfide from a biogas are provided. The methods may include and the apparatuses may be used for moving the solid waste in a corkscrew-like fashion through a closed container. The method may further include moving the high-solids waste into contact with a heating device to facilitate the corkscrew-like movement. Other methods and apparatuses may use at least one of a partition and a conduit from which liquid or gas is discharged. The invention also relates to methods and apparatuses for reducing the amount of H₂S in a biogas produced from an anaerobic digester.

### CROSS-REFERENCE TO RELATED APPLICATIONS

This application claims priority to provisional patent application No. 61/214,429 filed on Apr. 23, 2009, and is incorporated by references in its entirety.

### FIELD

The invention relates to waste-processing systems for processing manure. In another embodiment, the invention relates to a method for reducing hydrogen sulfide in a biogas. In still another embodiment, the invention relates to a method for reducing hydrogen sulfide in a biogas produced through anaerobic digestion.

### BACKGROUND

Livestock confinement facilities generate large amounts of animal waste that can create serious environmental and human health concerns. For example, animal waste constituents such as organic matter, nitrogen, phosphorus, pathogens and metals can degrade water quality, air quality, and adversely impact human health. Organic matter, for example, contains a high amount of biodegradable organics and when discharged to surface waters will compete for, and deplete the limited amount of dissolved oxygen available, causing fish kills and other undesirable impacts. Similarly nutrient loading from nitrogen and phosphorus can lead to eutrophication of surface waters.

The annual accumulation of organic waste in the world is immense. There are approximately 450,000 Animal Feeding Operations (“AFOs”) in the United States. Common types of AFOs include dairies, cattle feedlots, and poultry farms. A single dairy cow produces approximately 120 pounds of wet manure per day. The waste produced per day by one dairy cow is equal to that of 20-40 people. If properly stored and used, manure from animal feeding operations can be a valuable resource.

There are three principal products of anaerobic digestion: biogas, digestate and water. Biogas is the ultimate waste product of the bacteria feeding off the input biodegradable feedstock, and is mostly methane and carbon dioxide, with a small amount hydrogen and trace hydrogen sulfide. Most of the biogas is produced during the middle of the digestion, after the bacterial population has grown, and tapers off as the putrescible material is exhausted. The gas may be stored in an enclosure on top of the roof or extracted and stored next to the facility in a gas holder.

The methane in biogas can be burned to produce both heat and electricity, usually with a reciprocating engine or microturbine often in a cogeneration arrangement where the electricity and waste heat generated are used to warm the digesters or to heat buildings. Excess electricity can be sold to suppliers or put into the local grid. Electricity produced by anaerobic digesters is considered to be renewable energy and may attract subsidies. Biogas does not contribute to increasing atmospheric carbon dioxide concentrations because the gas is not released directly into the atmosphere and the carbon dioxide comes from an organic source with a short carbon cycle.

Biogas may require treatment or ‘scrubbing’ to refine it for use as a fuel. Hydrogen sulfide (H₂S) is a trace by-product of the digestion process, which in gas form is toxic and highly corrosive. If the levels of hydrogen sulfide in the gas are high, gas scrubbing and cleaning equipment (such as amine gas treating) will be needed to process the biogas to within regionally accepted levels as determined by the U.S. Environmental Protection Agency. However, gas “scrubbers” are expensive systems to install, maintain and operate. In addition, the systems require a reactive media that needs to be replenished periodically, and the disposal of the spent material is problematic.

An alternative method has been the use of “biotrickling filter” technologies, which attempt to grow and maintain a colony of sulfur-eating bacteria to reduce H₂S. However, maintaining and growing the bacterial cultures, such that the various microbes function in a symbiotic relationship has been challenging and complex.

Furthermore, the presence of H₂S in the biogas produced by anaerobic digesters is costly to the users of the digesters, as H₂₅ causes mechanical equipment and metal structures to degrade more rapidly. Reducing the level of H₂S in a biogas results in lower operating costs derived from fewer oil changes for the biogas engines, increased equipment and infrastructure longevity. Thus, a need still exists for a method to reduce the amount of hydrogen sulfide in a biogas.

### BRIEF SUMMARY

The apparatus and method embodying the invention provide a waste-processing system capable of processing high-solids waste and reducing the amount of hydrogen sulfide present in the resulting biogas. One aspect of the invention may provide an organic waste material processing system for the anaerobic digestion of high-solids waste comprising a closed container for holding high solids waste material. The closed container may include a first passage in which the waste material flows in a first direction. The first passage may have first and second ends and the first end may include an inlet for waste material. The closed container may further include a second passage in which the waste material flows in a second direction opposite the first direction. The second passage also may have first and second ends, the second end including an outlet. The first passage and the second passage of the closed container may be separated by a divider. The first passage and the second passage may be arranged such that the second end of the first passage is adjacent the first end of the second passage, and the first end of the first passage is adjacent the second end of the second passage. In one embodiment, the container may be used for moving high-solids waste in a corkscrew-like fashion through at least one of the first passage and the second passage.

In another aspect, the invention may or may not provide a waste-processing system utilizing a heating device containing heating medium and a partition. A conduit having nozzles may or may not be utilized. A liquid or gas may be discharged therefrom to further agitate the waste material.

In another aspect, the invention may provide a method for the anaerobic digestion of high-solids waste. The method comprises moving the solid waste in a corkscrew-like fashion through the container. The method may or may not further comprise moving the high-solids waste into contact with a heating device in the closed container, and/or using a conduit from which liquid or gas is discharged, to facilitate the movement of the solid waste in a corkscrew-like fashion.

In another aspect, the invention relates to method for reducing the amount of H₂S in a biogas. In still another aspect, the invention relates a method for reducing the amount of H₂S in a biogas comprising introducing air, oxygen, or air and oxygen into an anaerobic digester vessel through the circulation system of the digester.

In still another aspect, the invention relates to a system to reduce H₂S in a biogas. In another embodiment, the biogas is from an anaerobic digester. The system comprises a positive displacement device with a low pressure inlet and a high pressure outlet. The system also comprises an apparatus with a first port, which is coupled to the low pressure inlet, a second port, which is coupled to the high pressure outlet, and a third port. A gas eductor is coupled to the third port of the apparatus, and creates suction via the venturi principle. Measured and precise amounts of air, oxygen, or air and oxygen are taken in through the third port of the gas eductor. The air, oxygen, or air and oxygen is added to the biogas stream. The biogas is compressed by the positive displacement device and recirculated back into the digester. The biogas can be injected near the floor of the anaerobic digester and increase the flow of sludge, which is circulating in a corkscrew like path.

In yet another embodiment, the system comprises a mass flow controller coupled to the gas eductor. The system can also comprise a mass flow meter. A measured amount of air is circulated into the system by a motorized mass flow controller. The set-point for the mass flow controller is determined by a mass flow meter that measures the total biogas generated by the digester. In yet another embodiment, the mass flow controller and the mass flow meter function to create a ratio that allows the oxygen and the H₂S to react and produce sulfur dioxide, but not introduce excess air into the system. In still another embodiment, the biogas/air dose ratio is fixed and tied to biogas production, such that as more biogas is produced, more air is allowed into the system. In another embodiment, a constant, fixed ratio of biogas to air, oxygen or air and oxygen is maintained. In still another embodiment, the ratio of biogas to air is 20:1.

In yet another aspect, the invention relates to a method comprising passing biogas through a low pressure inlet of a positive displacement device, wherein the positive displacement device also comprises a high pressure outlet, passing the biogas to an apparatus located between the low pressure and high pressure sides of the positive displacement device, wherein a gas eductor is coupled to said apparatus, adding air, oxygen, or air and oxygen through a third port on the gas eductor to the biogas, compressing the biogas, and returning the compressed biogas to the digester vessel.

In yet another embodiment, the method comprises controlling the amount of air, oxygen, or air and oxygen that enters the gas eductor through use of a mass flow controller coupled to the third port of the apparatus.

The mass flow controller may comprise a motorized control valve that meters an amount of oxygen or air that enters the system. The mass flow controller measures the volume of air, oxygen, or air and oxygen passing through the valve body by opening and closing a valve to accept the desired ratio of air, oxygen, or air and oxygen to the biogas dose. In yet another aspect, the method comprises measuring the amount of biogas produced by the digestor with a mass flow sensor, which in turn continuously communicates to a mass flow controller, which regulates the amount of air, oxygen or air and oxygen allowed into the system.

In still another aspect, the method comprises producing a specific ratio of biogas to air by precise communication between the mass flow controller and the mass flow sensor.

In still another aspect, an air filter is coupled to the third port of the gas eductor. A manual shut-off valve may be coupled to the third port of the gas eductor to control the flow of air into the third port.

An advantage of the invention is a process for reducing the amount of hydrogen sulfide in a biogas.

An advantage of the invention is the production of biogas with reduced levels of hydrogen sulfide.

An advantage of the invention is the removal of hydrogen sulfide from a biogas.

An advantage of the invention is the use of biogas, wherein air, oxygen, or air and oxygen has been added, to increase the movement of the heated sludge in a corkscrew like flow path.

Other features and aspects of the invention are set forth in the following drawings, detailed description and claims.

### BRIEF DESCRIPTION OF THE DRAWINGS

FIG. 1 is a schematic view of a waste processing system embodying the invention.

FIG. 2 is a partial cross-section elevational view of the digester of the waste processing system shown in FIG. 1.

FIG. 3 is a cross-section elevational view of a wall between a mixing chamber and the digester and taken along the 3-3 line of FIG. 1.

FIG. 4 is a partial cross-section elevational view of a clarifier, taken along the 4-4 line of FIG. 1.

FIG. 5 is a perspective view of a composter of the waste processing system shown in FIG. 1.

FIG. 6 is a cross-sectional view of the composter taken along the 6-6 line in FIG. 5.

FIG. 7 is a flowchart of the process employed in the waste processing system shown in FIG. 1.

FIG. 8 is a view similar to FIG. 7 and shows an alternative process of the invention.

FIG. 9 is a view similar to FIGS. 7 and 8 and shows another alternative process of the invention.

FIG. 10 is a view similar to FIGS. 7 and 9 and shows another alternative process of the invention.

FIG. 11 is an enlarged view of a portion of the waste processing system shown in FIG. 1.

FIG. 12 is a schematic view of an alternative waste processing system embodying the invention.

FIG. 13 is a partial cross-sectional view of a digester taken along the 13-13 line in FIG. 12.

FIG. 14 is a partial cross-section elevational view of the digester taken along the 14-14 line in FIG. 12.

FIG. 15 is a photograph of a system that can be used to introduce air into biogas in accordance with at least some aspects of the invention.

FIG. 16 is a photograph of a mass flow meter that can be used to determine an amount of biogas produced by a digester in accordance with at least some aspects of the invention.

FIG. 17 is a photograph of a removable/cleanable detection probe from the mass flow meter that inserts into the biogas piping for the purpose of measuring total biogas production.

FIG. 18 is a flowchart depicting a relationship between a waste processing system and a system to reduce hydrogen sulfide in a biogas in accordance with at least some aspects of the invention.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION

### Definitions

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, viscosity, melt index, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, relative amounts of components in a mixture, and various temperature and other parameter ranges recited in the methods.

The term “passing” encompasses moving, flowing, transporting, circulating or locating an item from one location to a second location. “Passing” may occur unhindered and naturally or “passing” may occur with mechanical or chemical assistance.

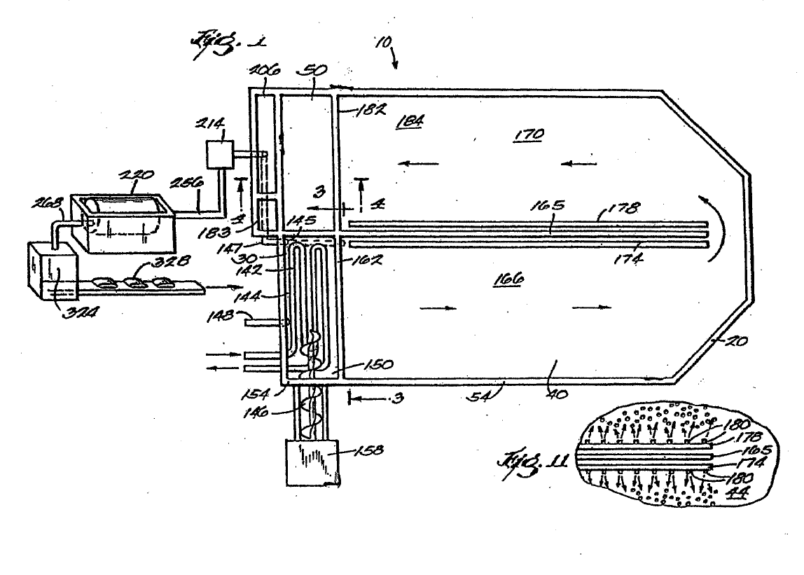

A waste-processing system 10 embodying the invention is illustrated in FIGS. 1-10. FIGS. 1-6 show the apparatus in which the process is conducted. The system 10 is described in terms of processing manure, but may also be used to process wood pulp, municipal wastes, or organic waste products in general.

FIG. 1 shows schematically the apparatus used to process high-solids farm waste. A digester enclosure 20 includes three major sections: a mixing chamber 30, a digester 40, and a clarifier 50. The digester enclosure 20 is arranged such that a relatively large digester 40 may be built in relatively small space.

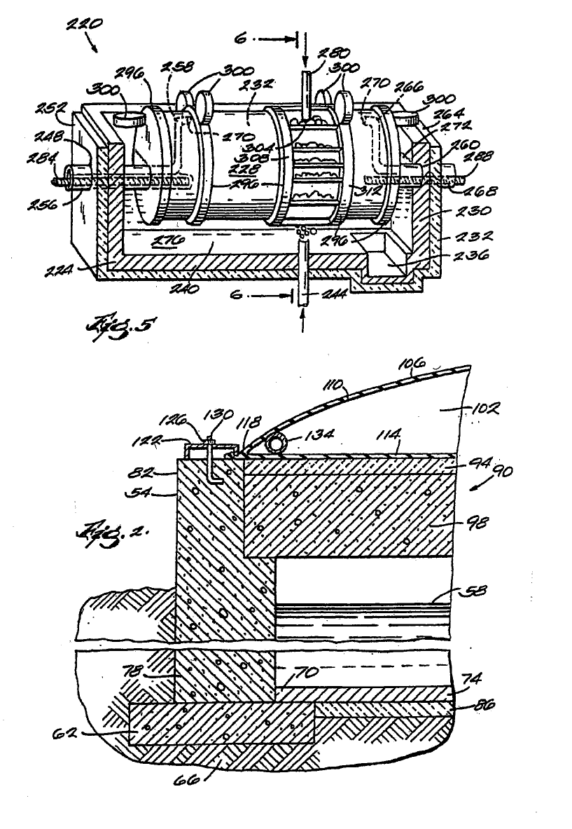

FIG. 2 illustrates the construction of an outside wall 54 of the digester enclosure 20. The height of the outer wall 54 of the digester enclosure 20 is approximately 17 feet, with a liquid depth 58 in the digester enclosure 20 of approximately 14 feet and a biogas storage area 59 of about 18 inches above the liquid 58. A footing 62 provides an interface between the wall 54 and the ground 66, and supports the wall 54 and the edge 70 of the floor 74. Both the footing 62 and the wall 54 are constructed of poured concrete. The wall 54 is approximately twelve inches thick at the lower end 78 of the wall 54, and approximately eight inches thick at the upper end 82 of the wall. The floor 74 of the digester enclosure 20 is approximately four inches of concrete. Insulation 86 with a thickness of approximately four inches may be arranged below the floor 74 and provides an interface between the floor 74 and the ground 66.

The roof 90 of the digester enclosure 20 is located approximately 15 feet, 8 inches above the floor 74 of the digester enclosure 20. The roof 90 is constructed of an approximately ten-inch thickness 98 of SPANCRETE concrete topped by a layer of insulation 94 with a thickness between four and eight inches, and more particularly, between three and four inches.

A biogas storage chamber 102 may be located above the roof 90. The primary component of the chamber 102 is a liner 106 including an upper liner section 110 and a lower liner section 114. The liner 106 is preferably constructed from high-density polyethylene (HDPE), but may be any other suitable material. The liner 106 is sealed around the edges 118 of the liner 106 by capturing the edges 118 beneath six-inch channel iron 122, which is irremovably attached to the digester enclosure walls 54 using nuts 126 on a plurality of anchor bolts 130 embedded in the digester enclosure wall 54. A ten-inch PVC pipe 134 is inserted around the periphery of the chamber 102 within the liner 106 to assist in maintaining the seal around the periphery of the liner 106. The liner 106 is constructed such that it can flexibly fill with biogas as the biogas is produced in the digester 40, and can be emptied of biogas as is needed. The biogas storage chamber 102, as an addition to biogas storage 59 within the digester enclosure 20, may be replaced by any other suitable gas storage system including a roofed storage system.

Returning to FIG. 1, the mixing chamber 30 has horizontal dimensions of approximately 36 feet by 15 feet. Arranged within the mixing chamber 30 is approximately 2000 feet of three or four-inch black heating pipe 142, which is designed to carry hot water to heat sludge 144 within the mixing chamber 30. An influent pipe 148 carries manure 336 into the mixing chamber 30. The closed container may further include a heating device and may or may not include a partition. The heating device may comprise a conduit containing a liquid or gas with discharge nozzles to further agitate the waste material, positioned to heat waste material to form heated waste material. Mixing within the mixing chamber 30 is provided by at least one of a system of mixing nozzles utilizing recirculated biogas (the nozzles being on the end of an activated sludge recirculation pipe 147) and convective flow resulting from the heating of the manure 336 by the heating pipe 142. In one embodiment, the recirculation pipe may deliver effluent to the digester 166, in another embodiment to the mixing chamber 30. If required, a standard auger 146 used for removing solids from the mixing chamber 30 is arranged near the floor 150 of the mixing chamber 30 such that it can transport solids from the floor 150 of the mixing chamber 30 through the wall 154 of the mixing chamber 30 and to a collection device 158. The collection device 158 is optional. In another embodiment (not shown), solids may be removed from the mixing chamber 30 by any other suitable system, such as a sump pump.

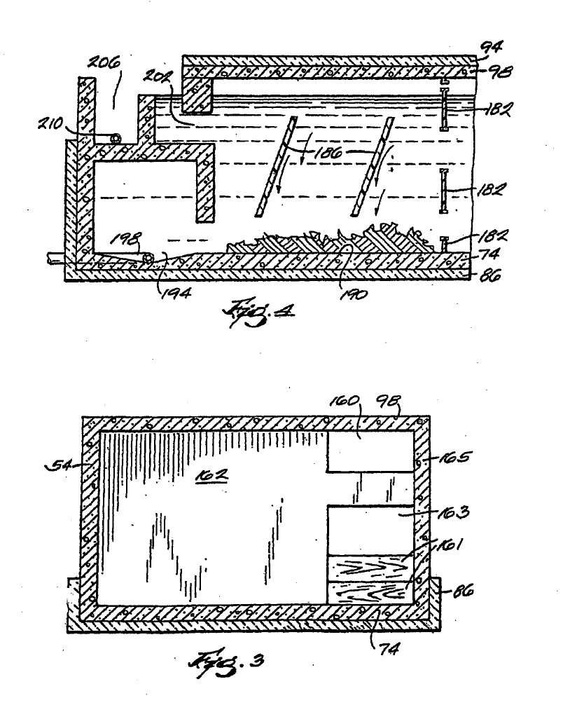

As illustrated in FIG. 3, a cutout 160 formed in the wall 162 between the mixing chamber 30 and the digester 40 allows sludge to flow from the mixing chamber 30 into the digester 40. In addition, removable panels 161 may be positioned to block opening 163 in the wall 162. The removable panels shown in FIG. 3 are optional. Removable panels 161 may be removed as needed to allow greater flow from mixing chamber 30 to digester 40, if desired.

Returning to FIG. 1, the digester 40 is a generally U-shaped tank with overall horizontal dimensions of approximately 100 feet long and 72 feet wide. A center wall 165 approximately 90 feet in length divides the digester 40 into the two legs 166, 170 of the U-shape. Thus each leg 166, 170 of the digester 40 is approximately 100 feet long and 36 feet wide.

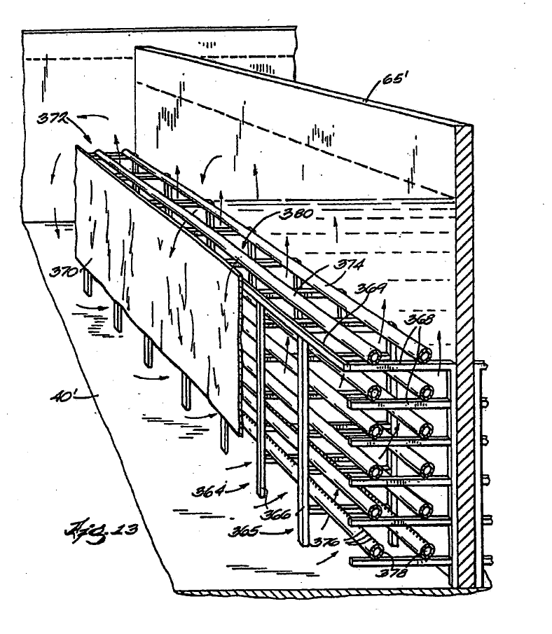

The first leg 166 of the digester 40 includes approximately 800 feet of three or four-inch black heating pipe 174 through which heated water or gas can flow. The heating pipe 174 is or separate gas pipes are arranged along the center wall 165. The second leg 170 of the digester 40 includes approximately 200 feet of four-inch black heating pipe 178, which is also arranged along the center wall 165. In another embodiment illustrated in FIG. 11, the heating pipes 174, 178 or separate gas pipes 178 may include jet nozzles 180 to dispense heated gas or recycled biogas into the sludge 144.

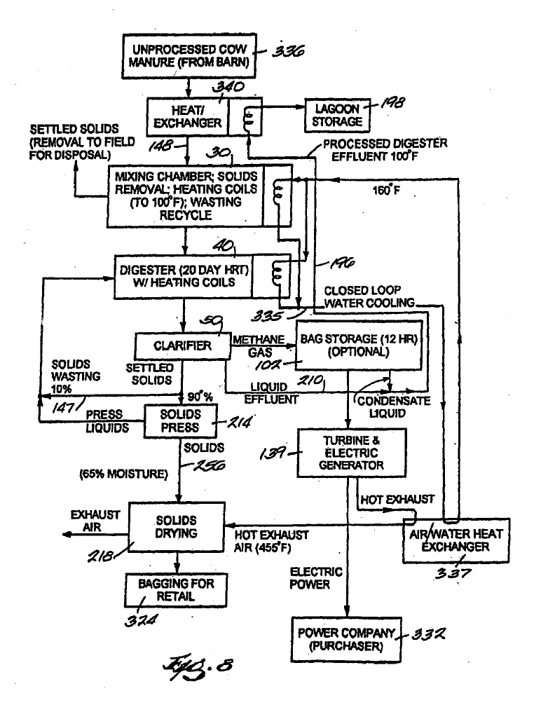

In addition to producing activated sludge 184, the anaerobic digestion of the digester 40 also produces bio gas in the form of methane gas, which is collected in the space above the liquid in digester 40 and below the roof 98 and can also be stored in the gas storage chamber 102. Any liquid that condenses within the chamber 102 is directed through the effluent pipe 196 (see FIGS. 7 9) to the liquid storage lagoon 198 (see FIGS. 7 9). The collected bio gas is used to fuel an internal combustion engine 138 (see FIG. 7) that, in combination with an electric generator, is used to produce electricity that is sold to a power utility 332 (see FIG. 7). The cooling system of the internal combustion engine 138 also produces hot coolant that is used for heating and agitation in the mixing chamber 30 and, alternatively, for heating and agitation in the mixing chamber 30 and digester 40. Hot water from the engine 138 passes through an air/water cooler 334 (see FIG. 7) to reduce the temperature of the water from the approximately 180° F. temperature at the exit of the engine 138 to approximately 160° F. for use in the mixing chamber 30 and the digester 40.

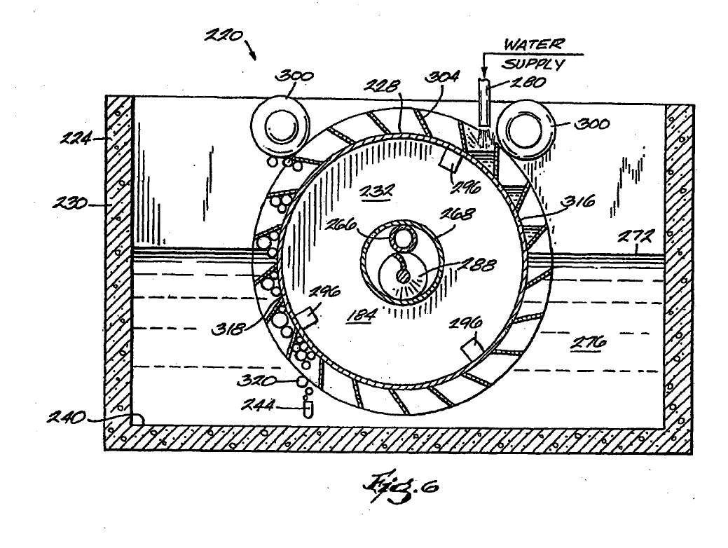

As shown in FIG. 1, the optional clarifier 50 is located adjacent the digester 40 beyond clarifier panels 182 and adjacent the mixing chamber 30. The clarifier 50 has horizontal dimensions of approximately 36 feet by 21 feet, and is largely empty of any equipment or hardware, with the exception of an equipment room 183. Turning to FIG. 4, the clarifier panels 182 are constructed from HDPE and form a partial barrier between the digester 40 and the clarifier 50. The clarifier panels 182 cover the entire horizontal dimension across the clarifier 50 from center wall 165 to outer wall 54. Separation panels 186 within the clarifier 50 serve to direct solids in a downward direction to the bottom 190 of the clarifier 50, where the solids collect in a sump 194. Sump pipe 198 leads to a standard solids press 214 (see FIGS. 7 9), and to the activated sludge recirculation pipe 147 carrying activated sludge 184 to the mixing chamber 30, or, alternatively, the digester 40 (see FIG. 1).

As illustrated in FIGS. 7-9, a portion of the liquid produced as a result of the operation of the solids press 214 may be recycled to the mixing chamber 30 or the digester 40 for further processing.

Returning to FIG. 4, liquids in the clarifier 50 decant through gap 202 and collect in a liquid sump 206. A liquid effluent pipe 210 within the liquid sump 206 leads through a heat exchanger 340 (see FIG. 7) and to a liquid storage lagoon 198 (see FIG. 7).

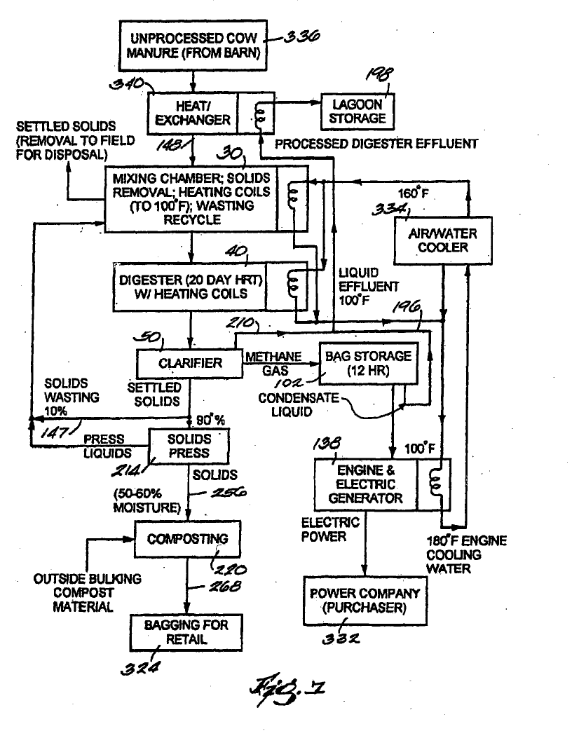

A composter 220 as illustrated in more detail in FIGS. 5 and 6 is located downstream of the solids press 214. The composter is optional. The primary components of the composter 220 include a water tank 224 and a composting barrel 228. The water tank 224 is generally a rectangular parallelepiped with six-inch-thick walls 230 constructed from concrete. A four-inch layer of insulation 232 (not shown in FIG. 6) covers the periphery of the walls 230. A sump 236 is located in the floor 240 of the water tank 224. Extending through the floor 240 of the water tank 224 is an air supply pipe 244. A port 248 in the first wall 252 of the water tank 224 accommodates a sludge supply pipe 256 that connects the solids press 214 with the composter barrel 228. A port 260 in the second wall 264 of the water tank 224 accommodates a composter solids exit pipe 268.

The water level 272 of the water tank 224 may be varied to provide buoyant support to the composter barrel 228; the water level 272 as illustrated in FIGS. 5 and 6 is representative of a typical level. The water 276 is typically at 140-160° F. A water inlet pipe 280 provides a flow of water 276 to the composter barrel 228 and the water tank 224. The water 276 is supplied from the cooler 334 of engine 138.

The composter barrel 228 defines an interior chamber 232. A sludge supply auger 284 is located within the sludge supply pipe 256 and extends from within the sludge supply pipe 256 into chamber 232 of the barrel 228. A composted solids exit auger 288 extends from within chamber 232 of barrel 228 into the composter solids exit pipe 268. Each pipe 256, 268 is connected to the ends 292, 294 of the composter barrel 228 using a double rotating union seal with an internal air pressure/water drain (not shown). The pipes 256, 268 and augers 284, 288 are designed such that air that is necessary for drying the sludge and for aerobic digestion may pass through the composter barrel 228. Air passes through solids exit pipe 268 and air inlet pipe 266, into the composter barrel 228, and out through air outlet pipe 258 and sludge supply pipe 256. The air pipes 258, 266 extend vertically to keep their ends 270 above the activated sludge 184 in the composter barrel 228.

The composter barrel 228 is generally cylindrical and approximately 100 feet long and 10 feet in diameter. A plurality of wear bars 296 is attached to the exterior circumference of the barrel 228. Rubber tires 300 acting on the wear bars 296 serve to hold the composter barrel 228 in position.

As illustrated in FIGS. 5 and 6, a plurality of vanes 304 is attached to the barrel 228. These vanes 304 extend between the third and fourth wear bars 308, 312. The vanes 304 are generally parallel to the longitudinal axis of the composter barrel 228. As shown in FIG. 6, to effect cooperation with the vanes 304, the water inlet pipe 280 and the air inlet pipe 244 are laterally offset in opposite directions from the vertical centerline of the composter barrel 228. As a result, when water 276 flows from the water inlet pipe 280, the water 276 collects on the vanes 304 on a first side 316 of the composter barrel 228, and when air 320 flows from the air inlet pipe 244, air 320 collects under the vanes 304 on a second side 318 opposite the first side 316 of the composter barrel 228. The lateral imbalance resulting from weight of water 276 on the first side 316 of the barrel 228 and the buoyancy of the air 320 on the second side of the barrel 228 causes the barrel 228 to rotate in a clockwise direction as viewed in FIG. 6.

The composter barrel 228 is slightly declined toward the exit end 294 of the composter barrel 228 to encourage the activated sludge 184 within the composter barrel 228 to move along the longitudinal axis of the composter barrel 228 toward the exit end 294. As shown in FIG. 6, the composter barrel 228 also includes internal baffles 296 that serve to catch and turn the activated sludge 184 as the composter barrel 228 rotates.

As illustrated in FIG. 1, the composter solids exit pipe 268 connects to a standard bagging device 324 that places the composted solids into bags 328 for sale.

In operation of the waste-processing system 10, as illustrated in FIGS. 1 and 7, unprocessed cow manure 336 from area farms and other sources is transported to the waste processing site and transferred to a heat exchanger 340 where, if necessary, the manure 336 is thawed using warm water from the clarifier 50 by way of liquid effluent pipe 210.

Manure 336 is then transferred from the heat exchanger 340 to the mixing chamber 30 through influent pipe 148, where the manure 336 may, alternatively, be mixed with activated sludge 184 recycled from the clarifier 50 by way of activated sludge recirculation pipe 147 to become sludge 144. The sludge 144 is heated to approximately 95-130° Fahrenheit by directing coolant at approximately 160° F. from the engine cooler 334 through the mixing chamber heating pipes 142. In addition, if required, solids such as grit fall to the bottom of the mixing chamber 30 under the influence of gravity and are removed using the mixing chamber auger 146. The solids are then transferred to a disposal site.

After a stay of approximately one day in the mixing chamber 30, the sludge 144 flows through cutout 160 or opening 163 in the wall 162 and into the digester 40, where anaerobic digestion takes place. The activated sludge 184 added to the manure 336 in the mixing chamber 30 or digester 40 serves to start the anaerobic digestion process.

The apparatus and method described herein employ modified plug flow or slurry flow to move the sludge, unlike the plug flow in prior art systems. The digester heating pipes 174, 178 locally heat the sludge 144 using hot water at approximately 160° F. from the cooler 334 of the engine 138, causing the heated mixed sludge to rise under convective forces. The convection develops a current in the digester 40 that is uncharacteristic of prior art high-solids digesters. Sludge 144 is heated by the digester heating pipes 174, 178 near the digester center wall 165, such that convective forces cause the heated sludge 144 to rise near the center wall 165. At the same time, sludge 144 near the relatively cooler outer wall 54 falls under convective forces. As a result, the convective forces cause the sludge 144 to follow a circular flow path upward along the center wall 165 and downward along the outer wall 54. At the same time, the sludge 144 flows along the first and second legs 166, 170 of the digester 50, resulting in a combined corkscrew-like flow path for the sludge 144.

In another embodiment (not shown), hot gas injection jets using heated gases from the output of the engine 138 replace the hot water digester heating pipes 174, 178 as a heating and current-generating source. The injection of hot gases circulates the sludge 144 through both natural and forced convection. A similar corkscrew-like flow path is developed in the digester 40.

As shown in FIG. 11, to further increase upward flow of the heated sludge 14 near the center wall 165, biogas may be removed from the biogas storage area 59 in the digester 40, pressurized with a gas centrifugal or rotary-lobe blower, and injected into the heated sludge 144 through nozzles 376 positioned onto conduit 378. This recycled biogas injection near the floor 74 of the digester 40 serves to increase the rapidity of the cork-screw-like flow path for the heated sludge 144.

In the arrangement shown in FIG. 1, the U-shape of the digester 40 results in a long sludge flow path and thus a long residence time of approximately twenty days. As the sludge 144 flows through the digester 40, anaerobic digestion processes the sludge 144 into activated sludge 184. The anaerobic digestion process also reduces the phosphate content of the liquid effluent after solids removal, by approximately fifty percent, which is a key factor in meeting future environmental regulations.

From the digester 40 the activated sludge 184 flows into the optional clarifier 50. The clarifier 50 uses gravity to separate the activated sludge 184 into liquid and solid portions. Under the influence of gravity and separation panels 186, the liquid portion rises to the top of the mixture and is decanted through a gap 202 into a liquid sump 206. It is later transferred to lagoon storage 198 through effluent pipe 210. The liquid is then taken from the lagoon 198 for either treatment or use as fertilizer.

The solid portion of the activated sludge 184 settles to the bottom 190 of the clarifier 50 in sump 194. From there, approximately ten to twenty-five percent of the activated sludge 184 is recycled to the digester 40 or mixing chamber 30 through activated sludge recirculation pipe 147 to mix with the incoming manure 336, as described above. The remaining approximately seventy-five to ninety percent of the activated sludge 184 is removed from the clarifier 50 through sump pipe 198 and is transferred to the solids press 214 in which the moisture content of the activated sludge 184 is reduced to approximately sixty-five percent.

From the solids press 214, the activated sludge 184 is transferred through sludge supply pipe 256 using sludge supply auger 284 to the interior chamber 232 of the composter barrel 228 where the activated sludge 184 is heated and agitated such that aerobic digestion transforms the activated sludge 184 into usable fertilizer. Outside bulking compost material can be added to the chamber 232 to make the fertilizer more suitable for later retail sale. As the composter barrel 228 turns, baffles 296 within the chamber 232 agitate and turn the sludge. This agitation also serves to aerate the sludge to enhance aerobic digestion. At the same time, the tank of water 224 in which the barrel 228 sits heats the barrel 228. This heating also promotes aerobic digestion.

In the preferred embodiment, water 276 falling from the water inlet pipe 280 and air 320 rising from the air inlet pipe 244 collects on the vanes 304 and causes the composter barrel 228 to turn around its longitudinal axis. In other embodiments, direct motor or belt drives, or any other suitable drive mechanism may turn the composter barrel 228.

As the activated sludge 184 turns over and undergoes aerobic digestion in the chamber 232, it also travels longitudinally and eventually exits the composter barrel 228 through the composter solids exit pipe 268, driven by the composter solids exit auger 288. The processed sludge, which has become usable fertilizer at approximately forty-percent moisture, is transferred to a bagging device 324. In the bagging device 324, the processed sludge is bagged for sale as fertilizer.

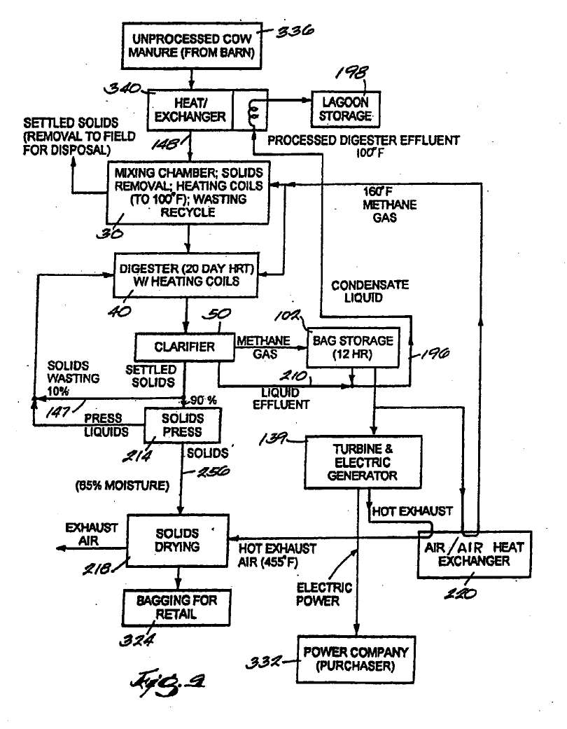

In an alternative embodiment illustrated in FIG. 8, a turbine 139 replaces the internal combustion engine as described above. The turbine 139 is preferably an AlliedSystems TURBOGENERATOR turbine power system as distributed by Unicom Distributed Energy, but may be any other suitable turbine. The turbine 139 is fueled by the methane collected in the biogas storage chamber 59 or 102. The differences with the use of a turbine 139 from the previously-discussed process are outlined as follows. Instead of an engine cooler 334 producing heated coolant, the turbine 139 produces exhaust gases at approximately 455° F. The hot exhaust gases are used to heat water in a closed loop 335 through an air/water heat exchanger 337. The heated water is then used for heating in the mixing chamber 30 and for heating and agitation in the digester 40. This embodiment is used in conjunction with a composter (not shown) as described above.

As shown in FIG. 8, the composter is replaced with a solids dryer 218 in which hot exhaust from the turbine 139 or reciprocating engine 138 is used to dry the sludge taken from the solids press 214. From the solids dryer 218, the activated sludge 184 is transferred to a bagging device 324. In the bagging device 324, the processed sludge is bagged for sale as fertilizer.

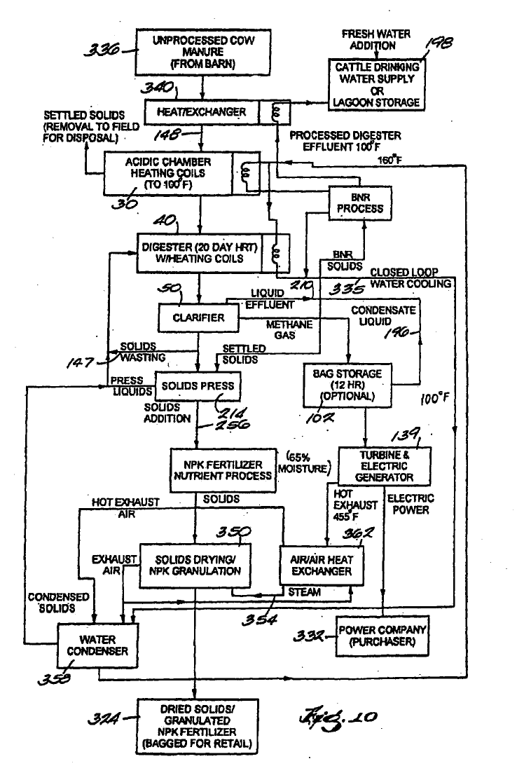

In another embodiment illustrated in FIG. 9, hot exhaust gases from the turbine 139 are used to heat methane from the bio gas storage chamber 102 to approximately 160° F. in an air/air heat exchanger 220. The heated methane is then injected into the mixing chamber 30 and the digester 40 for heating and agitation. In this embodiment, it is possible to seal off the digester 40 from any air contamination because only methane is used for heating and agitation. The methane is then recaptured in the bio gas storage chamber for reuse. This embodiment is used in conjunction with a composter (not shown) as described above.

In the embodiment illustrated in FIG. 9, the composter is replaced with a solids dryer 218 in which hot exhaust from the turbine 139 is used to dry the sludge taken from the solids press 214. Again, from the solids dryer 218, the activated sludge 184 is transferred to a bagging device 324. In the bagging device 324, the processed sludge is bagged for sale as fertilizer.

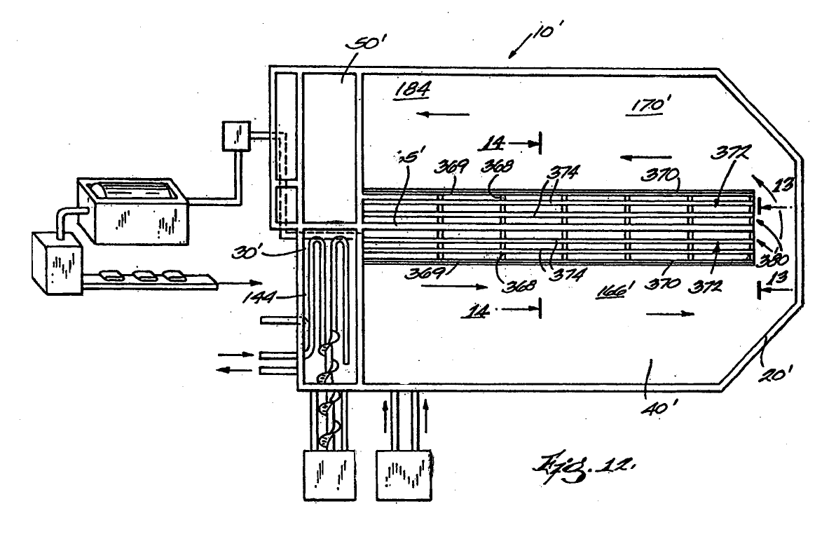

In still another embodiment illustrated in FIG. 10, a fluidizing bed dryer 350 takes the place of the composter or solids dryer described in previous embodiments. Pressed bio solids at approximately 35 percent solids from the solids press 214 enter the fluidizing bed dryer 350 where the solids are fluidized using heated air in a closed-loop air system 354. This fluidizing results in moisture from the bio solids being entrained in the heated air. The moisture-laden heated air passes through a water condenser 358 where water is removed from the heated air and circulated back to the heating pipe 142 in the mixing chamber 30 and to the heating pipe 174 in the digester 40. Heat is provided to the closed-loop air system 354 through an air/air heat exchanger 362. Hot exhaust gases from a series of turbines 139 provide heat to the air/air heat exchanger 362. The exhaust gases then enter the water condenser 358 to remove combustion moisture from the turbine exhaust before the remaining gases are vented to the atmosphere. The water condenser 358, in addition to recapturing water, also recaptures heat carried by the turbine exhaust and by the heated air in the closed-loop air system 354. This recaptured heat is used to heat the water circulating in the closed-loop water heating system.

The combination of a fluidizing bed dryer 350 and an air/air heat exchanger 362 recaptures heat produced by the turbines 139 that would otherwise be lost in the turbine exhaust. The heated air in the fluidizing bed dryer 350 evaporates water carried in the effluent from the solids press. The latent heat of vaporization carried by the moisture in the air leaving the fluidizing bed dryer 350 is substantially recaptured in the water condenser 358. The closed-loop air system 354 allows for air with reduced oxygen content to be used in the fluidizing bed dryer 350 to reduce the risk of fire associated with drying organic material. In addition, the closed-loop air system 354 allows for the addition of an auxiliary burner (not shown) if needed to process wetter material in the fluidizing bed dryer 350. A variable speed fan (not shown) can be added to the closed-loop air system 354 after the water condenser 358 to pressurize the air for the fluidizing bed dryer 350.

In the embodiment illustrated in FIG. 10, from the solids dryer 218, the activated sludge 184 is transferred to the bagging device 324. In the bagging device 324, the processed sludge is bagged for sale as fertilizer.

In another embodiment (not shown), the composter is replaced with a solids dryer 218 in which hot exhaust from the internal combustion engine 138 is used to dry the sludge taken from the solids press 214. Again, from the solids dryer 218, the activated sludge 184 is transferred to a bagging device 324. In the bagging device 324, the processed sludge is bagged for sale as fertilizer.

FIG. 12 illustrates another embodiment of the waste processing system of the present invention, wherein like elements have like numerals. Specifically, FIG. 12 illustrates a waste processing system 10′, which includes a digester enclosure 20′, a mixing chamber 30′, a digester 40′ and a clarifier 50′. A center wall 65′ divides the digester 40′ into a first leg 166′ and a second leg 170′. The sludge 144 can therefore move from the mixing chamber 30′into the digester 40′ along the first leg 166′ in a first direction, and toward the clarifier 50′ along the second leg 170′ of the digester 40′ in a second direction opposite the first direction.

The first leg 166′ and the second leg 170′, as illustrated in FIG. 12, each include a partition 370 positioned relative to the center wall 65′ such that a space 380 is created between the partition 370 and the center wall 65′. The partition may comprise at least one of a rigid board or plank, curtain or drape, tarp, film, and a combination thereof. In addition, the partition may be constructed of a variety of materials, including without limitation, at least one of a metal, wood, polymer, ceramic, composite, and a combination thereof. The first leg 166′ and the second leg 170′ each further include a heating device 372 positioned within the space 380 between the partition 370 and the center wall 65′ such that sludge 144 or activated sludge 184 (referred to from this point forward as sludge 144 for simplicity) is heated as it contacts the heating device 372. Heated sludge 144 rises relative to cooler sludge 144 by free convection and is allowed to rise upwardly within the space 380.

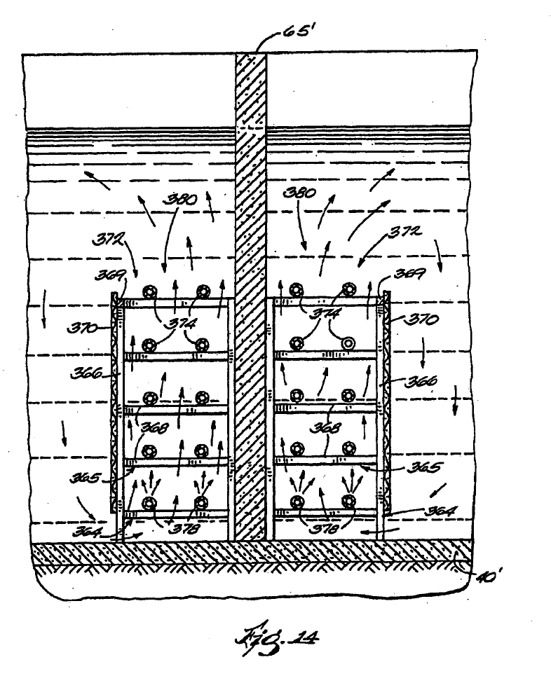

The heating device(s) 372 and the partition(s) 370 are shown in greater detail in FIGS. 13 and 14. For simplicity, one of the heating devices 372 and the partitions 370 will be described in greater detail, but it should be noted that the description may equally apply to the other heating device 372 and partition 370. As shown in FIGS. 13 and 14, the heating device 372 includes a series of conduits 374, each containing a heating medium. A variety of heating media may be used with the present invention, including at least one of water and a gas. The conduits 374 do not all need to contain the same heating medium. That is, some of the conduits 374 may contain a gas, while others contain a liquid, such as water.

As illustrated in FIGS. 13 and 14, the waste processing system 10′ may further include at least one conduit 378, which contains a compressed, recycled biogas from the biogas storage area 59 and has nozzles 376. The nozzles 376 are gas outlets. The compressed biogas contained in the conduit 378 flows through the conduit 378 and out the nozzles 376, such that as the gas escapes the conduit 378 via the nozzles 376, the gas is propelled upwardly in the space 380 to promote the sludge 144 to move upwardly through the principle of air/water lifting. FIGS. 13 and 14 illustrate two conduits 378 having nozzles 376. Any number of conduits 378 having nozzles 376 can be used without departing from the spirit and scope of the present invention. The nozzles 376 may be simple holes drilled into conduit 378 or may be specialized nozzles 376 attached to conduit 378 via welding or tapping.

Referring to FIGS. 13 and 14, a frame 364 is positioned within the space 380 to support the heating device 372 and the conduits 378. The frame 364 is illustrated as comprising a plurality of ladder-like units 365 and a connecting bar 369 running generally parallel to the center wall 65′ to connect the units 365. Each unit 365, as illustrated in FIGS. 13 and 14, is formed of two vertical columns 366 positioned on opposite sides of the space 380 and a plurality of crossbeams 368 connecting the two vertical columns 366 across the space 380. The frame 364 is illustrated by way of example only, and the present invention is in no way limited to the illustrated support structure. A variety of frame elements can be used to support the heating device 372, conduits 378, and/or other components of the waste processing system 10′ within the space 380 without departing from the spirit and scope of the present invention.

As illustrated in FIGS. 13 and 14, the partition 370 has a top edge 371 and a bottom edge 373. In addition, the illustrated partition 370 is substantially vertical and shorter in height than the digester 40′, such that heated sludge 144 can move over the top edge 371 of the partition 370 and out of the space 380 between the partition 370 and the center wall 65′, and cooled sludge 144 can move under the bottom edge 373 of the partition 370 and into the space 380. Therefore, as illustrated by the arrows in FIGS. 13 and 14, the partition 370, in conjunction with the heating device 372, promotes upward and downward movement of the sludge 144. This upward and downward movement of the sludge 144 results in an overall spiral movement of the sludge 144 as the sludge 144 is moved along the first and second legs 166′, 170′ of the digester 40′. Further promoting this spiral motion are the two conduits 378 with nozzles 376, which are located beneath the series of conduits 374 of the heating device 372 in FIGS. 13 and 14. The spiral motion of the sludge 144 throughout the digester 40′ promotes thermal mixing of the sludge 144 to produce activated sludge 184.

The series of conduits 374 illustrated in FIGS. 12 14 is formed by having a two-by-five configuration within the space 380 (i.e. two conduits 374 across and five conduits 374 up and down), with the conduits 374 running generally parallel to the center wall 65′. Another example is a two-by-six configuration, as shown in FIG. 13. In addition, two conduits 378 having nozzles 376 also run generally parallel to the center wall 65′ and are positioned beneath the series of conduits 374 just described. It should be noted, however, that any number of conduits 374 containing heating medium, and any number of conduits 378 having nozzles 376 arranged in a variety of configurations can be used without departing from the spirit and scope of the present invention. The series of conduits 374 and the conduits 378 having nozzles 376 depicted in FIGS. 12 14 are shown by way of example only.

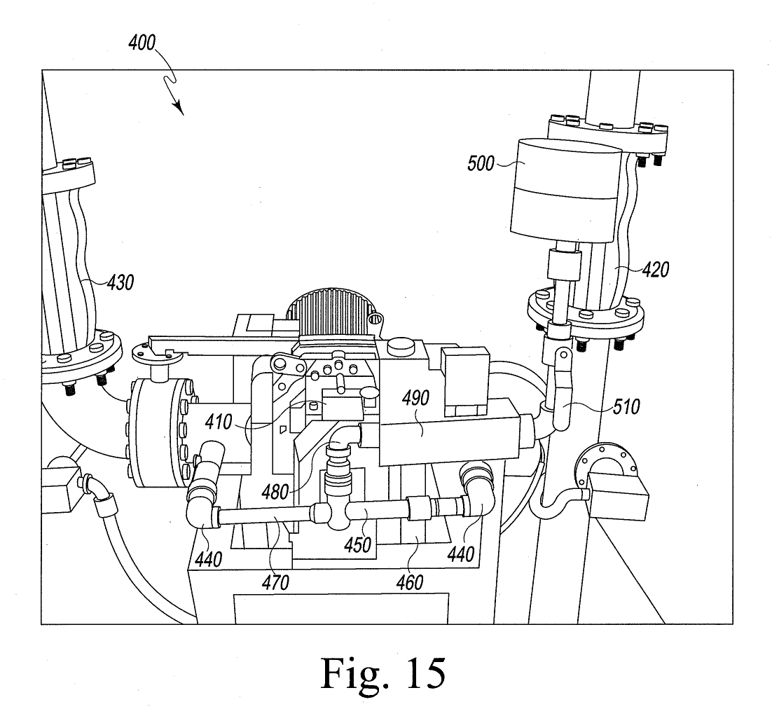

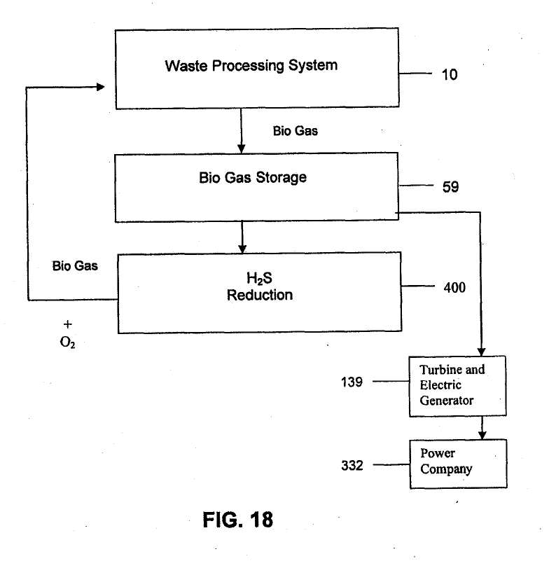

A system 400 embodying another aspect of the invention is illustrated in FIG. 15. FIG. 15 shows a system 400 that can be used to reduce H₂S in biogas produced from an anaerobic digester. The system 400 is described in terms of reducing H₂S in a biogas produced by the waste processing system 10 as described above, but can also be used with other types of anaerobic digesters (see FIG. 18). The recirculation system of the waste processing system 10 and the system 400 may be employed with other anaerobic digesters to reduce H₂S in a biogas.

In another embodiment, the invention relates to methods and apparatuses to introduce a controlled amount of air, oxygen or air and oxygen in a biogas stream. In another embodiment, the invention relates to a method of introducing air into a biogas stream, and introducing the altered biogas into an anaerobic digestor. In another embodiment, the altered biogas, which has now been mixed with air, oxygen, or air and oxygen, can be injected near the floor of a digester, and serves to increase the rapidity of a cork-screw like flow path for the heated sludge.

FIG. 15 shows schematically a system 400 used to reduce hydrogen sulfide in a biogas. The system 400 comprises a positive displacement device 410 with a low pressure inlet 420, and a high pressure outlet 430. Biogas may be removed from the biogas storage area 59 in the digester 40 or from the storage chamber 102 above the roof 90. In another embodiment, the biogas produced by the anaerobic digester may not be stored but rather instantaneously circulated to a positive displacement device 410. A positive displacement device 410, which has a low pressure inlet 420 and a high pressure outlet 430, can be used to compress biogas from an anaerobic digester. The positive displacement device includes but is not limited to a roots blower, a gear pump, a Sprintex supercharger, centrifugal supercharger, a chain pump, and any similar device.

In some embodiments, the positive displacement device is a roots blower. The roots blower is described as a rotary lobe blower in which a pair of lobed impellers with an approximate “FIG. 8” shape is mechanically linked with gears so that the lobes rotate in opposite directions. The lobes are dimensioned so that a close clearance is maintained between the lobes and the housing in which they rotate.

In another embodiment, the positive displacement device can be a Sprintex supercharger, which utilizes two screws, one male and one female to compress the charger. Like the Roots blower, the lobes on the rotors or screws do not touch. The charge is compressed as it travels through the rotation of the screws and can achieve large percentage of volume compression above 60%.

In still another embodiment, the positive displacement device can be a centrifugal supercharge, which increases the pressure of the intake air by utilizing a compressor powered by an engine. A centrifugal supercharger is an inertial compressor that behaves much like a fan, or a true “blower.” The centrifugal supercharger utilizes an impeller encased in a housing shaped with spiral land chambers like a snail's shell. An inlet hole is located at the center of the impeller and the outlet is at the end of spiral chamber (or volute).

Returning back to FIG. 15, the system 400 also comprises an apparatus 440 that creates a path between the low pressure inlet and the high pressure outlet. The apparatus 440 can be made of various materials including but not limited to plastic or metal. Specific examples of such materials include but are not limited to PVC, polyethylene, polypropylene, methacrylic or acrylic plastic, fiber glass reinforced plastic (FRP), or stainless steel.

As shown in FIG. 15, a gas eductor 450 may be coupled to the apparatus 440. The gas eductor comprises a first port 460, a second port 470, and a third port 480. A measured amount of air, oxygen, or air and oxygen may be taken through the third port 480 of the gas eductor 450. The air, oxygen, or air and oxygen is added to the biogas stream, compressed by the positive displacement device and returned to the digester vessel. The compressed biogas is injected into the heated sludge 144 through nozzles 376 positioned onto the conduit 378. This biogas, which has now been mixed with air, oxygen, or air and oxygen, can be injected near the floor 74 of the digester 40, and serves to increase the rapidity of the cork-screw like flow path for the heated sludge 144. Heating pipes can be used to enhance convection and facilitate the cork-screw like flow path.

The gas eductor 450 creates suction via the venturi principle. Any device that can create suction via the venturi principle may be used. The gas eductor 450 can be made of various materials including but not limited to plastic or metal. Specific examples of such materials include but are not limited to PVC, polyethylene, polypropylene, methacrylic or acrylic plastic, fiber glass reinforced plastic (FRP), iron or stainless steel. Any other materials, known in the art for making eductors may also be used.

Common to any venturi-style device is an inlet orifice for a motive stream, where the diameter of the inlet orifice is larger than the smallest diameter in a converging flow-path. Immediately downstream of the converging flow-path is a mixing zone having a diameter larger than the smallest restriction in the converging zone. Transverse to the motive flow path, a port is tapped into an eductor body such that an eduction flow path communicates with the motive flow path at the mixing zone. Bernoulli's equation demonstrates that suction is created in the mixing zone allowing a second solution to be drawn, or educted, into the mixing zone. It is through this transverse path that suction draws mentioned second fluid into the mixing zone whereby the second fluid and motive fluid become mixed. Downstream from the mixing zone the flow path diverges or widens in cross-section to conduct the mixture of motive fluid and educted second fluid to the eductor outlet.

Turning back to FIG. 15, another component of the system 400 is a mass flow controller 490. A mass flow controller 490 can be used to precisely measure and control the amount of air, oxygen, or air and oxygen that is introduced into the gas eductor 450. The mass flow controller 490 also can be designed to shut-off when power to the positive displacement device 410 is shut off for any reason. The mass flow controller 490 also can be designed to shut-off when biogas production drops below a desired level.

This regulatory system helps to ensure that air is not entered into the waste processing system 10 when biogas is not being produced. It is to be understood that the mass flow controller could be used to control the amount of any fluid entering the system including but not limited to liquids, gases, and slurries comprising any combination of matter or substance to which controlled flow may be of interest. A mass flow controller can be obtained from a variety of commercial sources including but not limited to Alicat Scientific (Tucson, Ariz.), Omega Engineering (Stanford, Conn.), Bronkhorst High-Tech (Netherlands), Teledyne Hastings Instruments (Hampton, Va.), Aalborg (Orangeburg, N.Y.), Brooks Instrument (Hatfield, Pa.), Sensirion (Westlake Village, Calif.), Sierra Instruments (Monterey, Calif.), Lambda Instruments (Switzerland), and Leister Technologies (Itasca, Ill.).

In another embodiment, the mass flow controller and the Roots blower, which supplies the motive pressure for the system, can be interrelated so that if the Roots blower shuts off, fails for any reason, or electrical power to the system is lost, the Mass Controller valve will automatically shut off the flow of air. A manual on/off switch also can be installed on a control panel.

Conventional mass flow controllers generally include four main portions: a flow meter, a control valve, a valve actuator, and a controller. The flow meter measures the mass flow rate of a fluid in a flow path and provides a signal indicative of that flow rate. The flow meter may include a mass flow sensor and a bypass. The mass flow sensor measures the mass flow rate of fluid in a sensor conduit that is fluidly coupled to the bypass. The mass flow rate of fluid in the sensor conduit is approximately proportional to the mass flow rate of fluid flowing in the bypass, with the sum of the two being the total flow rate through the flow path controlled by the mass flow controller. However, it should be appreciated that some mass flow controllers may not employ a bypass, as such, all of the fluid may flow through the sensor conduit.

In many mass flow controllers, a thermal mass flow sensor is used that includes a pair of resistors that are wound about the sensor conduit at spaced apart positions, each having a resistance that varies with temperature. As fluid flows through the sensor conduit, heat is carried from the upstream resistor toward the downstream resistor, with the temperature difference being proportional to the mass flow rate of the fluid flowing through the sensor conduit and the bypass.

A control valve is positioned in the main fluid flow path (typically downstream of the bypass and mass flow sensor) and can be controlled (e.g., opened or closed) to vary the mass flow rate of fluid flowing through the main fluid flow path, the control being provided by the mass flow controller. The valve is typically controlled by a valve actuator, examples of which include solenoid actuators, piezoelectric actuators, stepper actuators, etc.

Control electronics control the position of the control valve based upon a set point indicative of the mass flow rate of fluid that is desired to be provided by the mass flow controller, and a flow signal from the mass flow sensor indicative of the actual mass flow rate of the fluid flowing in the sensor conduit. Traditional feedback control methods such as proportional control, integral control, proportional-integral (PI) control, derivative control, proportional-derivative (PD) control, integral-derivative (ID) control, and proportional-integral-derivative (PID) control are then used to control the flow of fluid in the mass flow controller. In each of the aforementioned feedback control methods, a control signal (e.g., a control valve drive signal) is generated based upon an error signal that is the difference between a set point signal indicative of the desired mass flow rate of the fluid and a feedback signal that is related to the actual mass flow rate sensed by the mass flow sensor.

Many conventional mass flow controllers are sensitive to component behavior that may be dependent upon any of a number of operating conditions including fluid species, flow rate, inlet and/or outlet pressure, temperature, etc. In addition, conventional mass flow controllers may exhibit certain non-uniformities particular to a combination of components used in the production of the mass flow controller which results in inconsistent and undesirable performance of the mass flow controller.

An air filter 500 coupled' to the mass flow controller 490, which is coupled to the third port 480 of the gas eductor 450 also is shown in FIG. 15. The air filter 500 can be used for the removal of particulate matter. The air filter may be replaceable, washable, or replaceable and washable. A manual valve 510 may be coupled to the mass flow controller 490 to regulate the intake of air, oxygen or air and oxygen.

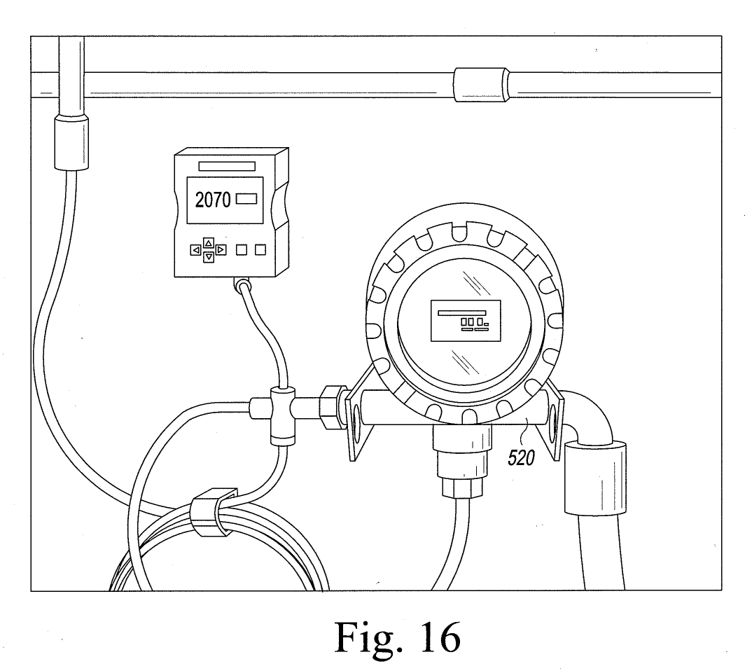

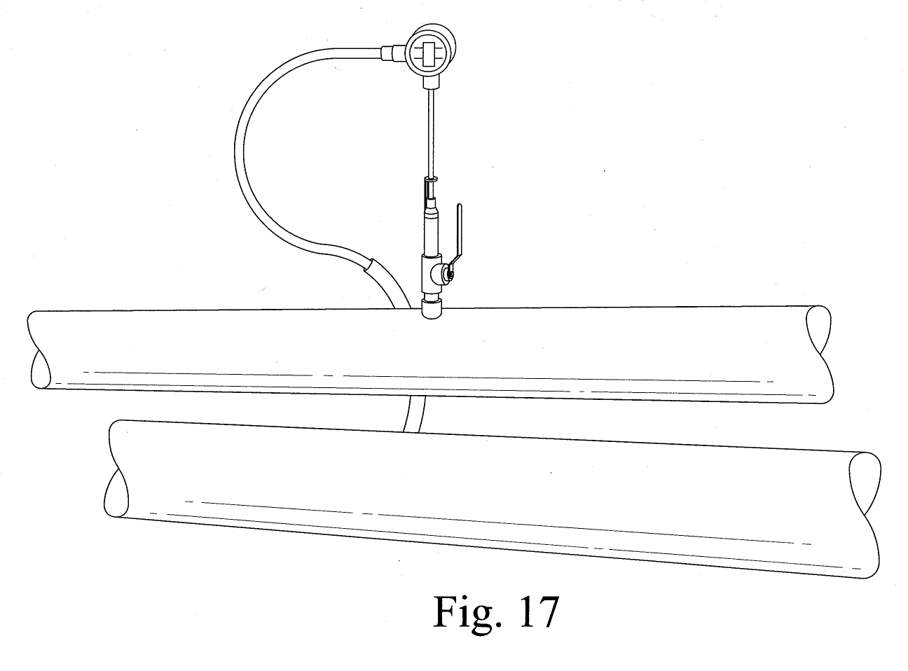

An additional component of the system 400 is shown in FIG. 16. FIG. 16 is a photograph of a mass flow sensor or meter 520. The mass flow sensor 520 is located near or adjacent to the indicator for the mass flow controller 490, so that the readouts can be easily read and the values compared. The mass flow meter is coupled to the mass flow controller via a USB cable.

The mass flow sensor 520 measures the amount of biogas that the digester is producing. A mass flow sensor, also known as inertial flow meter and coriolis flow meter, is a device that measures how much fluid is flowing through a tube. It does not measure the volume of the fluid passing through the tube; it measures the amount of mass flowing through the device. A mass flow sensor/meter can be obtained from a variety of commercial sources including but not limited to Alicat Scientific (Tucson, Ariz.), Omega Engineering (Stanford, Conn.), Bronkhorst High-Tech (Netherlands), Teledyne Hastings Instruments (Hampton, Va.), Sage Metering (Montery, Calif.), Brooks Instrument (Hatfield, Pa.), Sensirion (Westlake Village, Calif.), Sierra Instruments (Monterey, Calif.), Lambda Instruments (Switzerland), and Leister Technologies (Itasca, Ill.).

Volumetric flow metering is proportional to mass flow rate only when the density of the fluid is constant. If the fluid has varying density, or contains bubbles, then the volume flow rate multiplied by the density is not an accurate measure of the mass flow rate. In a mass flow meter the fluid is contained in a smooth tube, with no moving parts that would need to be cleaned and maintained, and that would impede the flow.

Vibrating conduit sensors, such as Coriolis mass flow meters, typically operate by detecting motion of a vibrating conduit that contains a flowing material. Properties associated with the material in the conduit, such as mass flow, density and the like, can be determined by processing measurement signals received from motion transducers associated with the conduit. The vibration modes of the vibrating material-filled system generally are affected by the combined mass, stiffness and damping characteristics of the containing conduit and the material contained therein.

A typical Coriolis mass flow meter includes one or more conduits that are connected inline in a pipeline or other transport system and convey material, e.g., fluids, slurries and the like, in the system. Each conduit may be viewed as having a set of natural vibration modes including, for example, simple bending, torsional, radial, and coupled modes. In a typical Coriolis mass flow measurement application, a conduit is excited in one or more vibration modes as a material flows through the conduit, and motion of the conduit is measured at points spaced along the conduit. Excitation is typically provided by an actuator, e.g., an electromechanical device, such as a voice coil-type driver, that perturbs the conduit in a periodic fashion. Mass flow rate may be determined by measuring time delay or phase differences between motions at the transducer locations. Two such transducers (or pickoff sensors) are typically employed in order to measure a vibrational response of the flow conduit or conduits, and are typically located at positions upstream and downstream of the actuator. The two pickoff sensors are connected to electronic instrumentation by cabling, such as two independent pairs of wires. The instrumentation receives signals from the two pickoff sensors and processes the signals in order to derive a mass flow rate measurement.

The mass flow sensor 520 communicates with the mass flow controller 490 to adjust the amount of air, oxygen, or air and oxygen. In one embodiment, the mass flow sensor 520 and the mass flow controller 490 function to create a ratio of biogas to air that provides sufficient oxygen to catalyze a reaction with the H₂S while not introducing excess air into the waste processing system 10. In another embodiment, a Pressure Swing Adsorption (PSA) oxygen concentrator can be used.

The ratio of biogas to air can be any ratio that produces the desired results including but not limited to a ratio of biogas to air of 50:1, 45:1, 40:1, 35:1, 30:1, 25:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, and 1:1. The ratio of biogas to air is maintained well-below the explosive limits.

The introduction of oxygen into the biogas stream will result primarily in the following reaction: 2H₂S+3O₂═2H₂0+2SO₂. Sulfur particles will fall out of the biogas envelope and into the liquid waste, which is pumped from the digester.

In still another embodiment, pure oxygen also may be mixed with the biogas stream. The use of pure oxygen allows you to sustain much higher oxygen uptake rates (OUR) than is possible using air due to the higher dissolved oxygen (DO) levels that can be maintained utilizing oxygen. The higher DO may promote faster oxygen utilization and incorporation into the biogas stream.

In yet another embodiment, the ratio of biogas to oxygen can be any ratio that provides sufficient oxygen to catalyze a reaction with the H₂S(2H₂S+3O₂═2H₂0+2SO₂) while not introducing excess air into the waste processing system 10. The ratio of biogas to oxygen includes but is not limited to 100:1, 99:1, 98:1, 97:1, 96:1, 95:1, 94:1, 93:1, 92:1, 91:1, 90:1, 85:1, 80:1, 75:1, 70:1, 65:1, 60:1, 55:1, 50:1, 45:1, 40:1, 35:1, 30:1, 25:1, 20:1, 15:1 and 10:1. The ratio of biogas to oxygen is maintained well-below the explosive limits.

In still another embodiment, the ratio of biogas to air and oxygen can be any ratio that provides sufficient oxygen to catalyze a reaction with the H₂S (2H₂S+3O₂═2H₂0+2SO₂) while not introducing excess air into the waste processing system 10. The ratio of biogas to air and oxygen includes but is not limited to 100:1, 99:1, 98:1, 97:1, 96:1, 95:1, 94:1, 93:1, 92:1, 91:1, 90:1, 85:1, 80:1, 75:1, 70:1, 65:1, 60:1, 55:1, 50:1, 45:1, 40:1, 35:1, 30:1, 25:1, 20:1, 15:1 and 10:1. The ratio of biogas to air and oxygen is maintained well-below the explosive limits.

By the methods and apparatuses of the invention, hydrogen sulfide in the biogas may be reduced from 3-5%, or from 5-10%, or from 10-20%, or from 20-30%, or from 30-40%, or from 40-50%, or from 50-60%, or from 60-70%, or from 70-80%, or from 80-90%, or from 90-95% or from 95-99%, or greater than 99%.

The methods and apparatuses of the invention may be used in conjunction with other methods for removal of hydrogen sulfide. Dry Removal of H₂S may involve the use of iron oxides, for example iron oxide impregnated wood chips (Connelly-GPM Inc., SulfaTreat, or Sulfur-Rite, frm GTP-Merichem) that selectively interact with H₂S and mercaptans. Regenerable iron-oxide based adsorption (for example Media-G2, form ADI International Inc.), zinc oxide for trace removal of H₂S at elevated temperatures (200° C.-400° C.; from Johnson Matthey Catalysts), or alkaline solids such as hydrated lime that react with H₂S (Molecular Products Ltd.), may also be used for this purpose as desired.

Liquid H₂S removal processes may include but are not limited to reacting H₂S with an alkaline compound in solution followed by exposure to iron oxide that reacts to form iron sulfide; regeneration is achieved by aeration converting the sulfide to elemental sulfur (e.g. GTP Merichem). Chelated-iron utilizing iron ions bound to a chelating agent may also be effectively used for liquid H₂₅ removal (lo-cat; GTP Merichem). Alkaline salts (caustic scrubbing) using hydroxide solutions may be used to neutralize H₂S acid gas (Dow Chemical Company). Alternatively, amines may be used to scavenge H₂S in liquid, such as Sulfa-Scrub; Q.₂ Technologies.

Treatment of H₂S may also take place within the digester, for example, by adding iron chlorides, phosphates and oxides added directly to the digester to bind with H₂S and form insoluble iron sulfides (ESPI Metals), or by introducing a small amount of oxygen into the head space of the digester or biogas storage tank to encourage growth of aerobic bacteria Thiobacillus. Alternative biological H₂S removal process may include using biofilters, fixed-film bioscrubbers and suspended-growth bioscrubbers, which have added functionality by often removing multiple contaminants from a gas stream; fluidized-bed bioreactors have been tested for simultaneous removal of H₂S and NH₃ (e.g. Biorem).

The system 400 can be located in any convenient location near or around the waste processing system 10 including but not limited to an engine room where the internal combustion engine 138 is located.

To this point, the system 400 has been described in relation to the waste processing system 10, and the digester 40 recited herein. However, the system 400 can be used with any type of anaerobic digester.

There are a myriad of anaerobic digester systems and scales in use around the world. These include simple unheated systems such as covered lagoons and more complex systems that are heated to about 100° F. or higher. Maintaining higher constant temperature reduces reactor volumes required to treat and stabilize waste.

In one embodiment, anaerobic digesters having any type of process configuration can be used including but not limited to batch, continuous, mesophilic temperature, thermophilic temperature, high solids, low solids, single stage complexity and multistage complexity. In another embodiment, a batch system of anaerobic digestion can be used. Biomass is added to the reactor at the start of the process in a batch and is sealed for the duration of the process. Batch reactors suffer from odor issues that can be a severe problem when they are emptied. Typically biogas production will be formed with a normal distribution pattern over time. The operator can use this fact to determine when they believe the process of digestion of the organic matter has completed.

In yet another embodiment, a continuous system of anaerobic digestion can be used. In continuous digestion processes, organic matter is typically added to the reactor in stages. The end products are constantly or periodically removed, resulting in constant production of biogas. Examples of this form of anaerobic digestion include, continuous stirred-tank reactors (CSTRs), Upflow anaerobic sludge blanket (UASB), Expanded granular sludge bed (EGSB) and Internal circulation reactors (IC).

In still another embodiment, mesophilic or thermophilic operational temperature levels for anaerobic digesters can be used. Mesophilic temperature level takes place optimally around 37°-41° C. or at ambient temperatures between 20°-45° C. and mesophiles are the primary microorganism present. Thermophilic temperature level takes place optimally around 50°-52° at elevated temperatures up to 70° C. and thermophiles are the primary microorganisms present.

There are a greater number of species of mesophiles than thermophiles. These bacteria are also more tolerant to changes in environmental conditions than thermophiles. Mesophilic systems are therefore considered to be more stable than thermophilic digestion systems.

In another embodiment, anaerobic digesters can either be designed to operate in a high solid content, with a total suspended solids (TSS) concentration greater than 20%, or a low solids concentration less than 15%. High-solids digesters process a thick slurry that requires more energy input to move and process the feedstock. The thickness of the material may also lead to associated problems with abrasion. High-solids digesters will typically have a lower land requirement due to the lower volumes associated with the moisture.

Low-solids digesters can transport material through the system using standard pumps that require significantly lower energy input. Low-solids digesters require a larger amount of land than high-solids due to the increase volumes associated with the increased liquid:feedstock ratio of the digesters. There are benefits associated with operation in a liquid environment as it enables more thorough circulation of materials and contact between the bacteria and their food. This enables the bacteria to more readily access the substances they are feeding off and increases the speed of gas yields.

In still another embodiment, digestion systems can be configured with different levels of complexity: one-stage or single-stage and two-stage or multistage. A single-stage digestion system is one in which all of the biological reactions occur within a single sealed reactor or holding tank. Utilizing a single stage reduces construction costs; however there is less control of the reactions occurring within the system. For instance, acidogenic bacteria, through the production of acids, reduce the pH of the tank, while methanogenic bacteria operate in a strictly defined pH range. Therefore, the biological reactions of the different species in a single stage reactor can be in direct competition with each other. Another one-stage reaction system is an anaerobic lagoon. These lagoons are pond-like earthen basins used for the treatment and long-term storage of manures. In this case, the anaerobic reactions are contained within the natural anaerobic sludge contained in the pool.

In a two-stage or multi-stage digestion system, different digestion vessels are optimized to bring maximum control over the bacterial communities living within the digesters. Acidogenic bacteria produce organic acids and more quickly grow and reproduce than methanogenic bacteria. Methanogenic bacteria require stable pH and temperature in order to optimize their performance.

The residence time in a digester varies with the amount and type of waste fibrous material, the configuration of the digestion system and whether it be one-stage or two-stage. In the case of single-stage thermophilic digestion residence times may be in the region of 14 days, which comparatively to mesophilic digestion is relatively fast. The plug-flow nature of some of these systems will mean that the full degradation of the material may not have been realized in this timescale. In this event digestate exiting the system will be darker in color and will typically have more odor.

In two-stage mesophilic digestion, residence time may vary between 15 and 40 days. In the case of mesophilic UASB digestion, hydraulic residence times can be (1 hour-1 day) and solid retention times can be up to 90 days. In this manner, the UASB system is able to separate solid and hydraulic retention times with the utilization of a sludge blanket.

Continuous digesters have mechanical or hydraulic devices, depending on the level of solids in the material, to mix the contents enabling the bacteria and the food to be in contact. They also allow excess material to be continuously extracted to maintain a reasonably constant volume within the digestion tanks.

The system 400 and the methods for reducing H₂S in a biogas from an anaerobic digester described herein offer several advantages over existing technologies. First, the system and the methods taught herein have low installation costs. In addition, distribution of the biogas stream with air, oxygen, or air and oxygen into the digester vessel can be accomplished with circulation system of the digester described herein.

Second, the system and methods for reducing H₂S have low operating costs. There is no media that needs to be replenished.

Third, the system and methods for reducing H₂S in a biogas are reliable. No additional mechanical pumps or compressors are needed to inject air into the system. Instead, the high-pressure side of the recirculation system's Roots blower can be used to create suction through the venturi principal. There are no additional moving parts.

Fourth, the system and methods for reducing H₂S in a biogas allows for precise control. The amount of air, oxygen, or air and oxygen introduced is constantly monitored and adjusted to maintain a constant ratio of biogas to air, oxygen or air and oxygen. When a digester produces more biogas, the increase in volume is detected and more air can be injected.

Farm digester gas is not the only source of sulfide contaminated methane rich gas for which the methods and apparatuses of the invention may be suitable. Wastewater treatment plants, landfills, paper mills, and food processing plants are all capable of producing biogas. Additionally, as higher quality natural gas wells are depleted, it may become economical to exploit smaller, remote, sulfur contaminated wells. The methods and apparatuses of the invention may be the ideal technology for sulfur removal from these gas sources.

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations that operate according to the principles of the invention as described. Therefore, it is intended that this invention be limited only by the claims and the equivalents thereof. The disclosures of patents, references and publications cited in the application are incorporated by reference herein.

We claim:

1. A method for reducing hydrogen sulfide in a biogas comprising
passing biogas through a low pressure inlet of a positive displacement device, wherein the positive displacement device also comprises a high pressure outlet;
passing the biogas from the low pressure inlet into an apparatus located between the low pressure and high pressure sides of the positive displacement device, wherein a gas eductor is coupled to said apparatus,
adding air through the gas eductor to the biogas;
compressing the biogas; and
passing the compressed biogas through the high pressure outlet to the digester vessel.

2. The method of claim 1, wherein said positive displacement device is a root's blower.

3. The method of claim 1, wherein said adding air is regulated through a mass flow controller.

4. The method of claim 3, further comprising measuring the amount of biogas produced by said anaerobic digestor.

5. The method of claim 4, wherein said measuring an amount of biogas is accomplished through a mass flow sensor.

6. The method of claim 5, wherein said mass flow sensor communicates with the mass flow controller to adjust the amount of air.

7. The method of claim 1, wherein a constant ratio of biogas to air is maintained.

8. The method of claim 1 further comprising returning said biogas to an anaerobic digestor.

9. The method of claim 8, wherein returning said biogas comprises injecting the biogas near the floor of the digester.

10. The method of claim 9, wherein the injected biogas increases the rapidity of a corkscrew like flow path for heated sludge in the anaerobic digestor.

11. A method for reducing hydrogen sulfide in a biogas comprising
passing biogas through a low pressure inlet of a positive displacement device, wherein the positive displacement device also comprises a high pressure outlet;
passing the biogas from the low pressure inlet into an apparatus located between the low pressure and high pressure sides of the positive displacement device, wherein a gas eductor is coupled to said apparatus,
measuring an amount of biogas produced by the digester, wherein the measurement is accomplished by a mass flow sensor;
adding a regulated amount of air through the gas eductor to the biogas, wherein the regulation is accomplished by a mass flow controller that communicates with the mass flow sensor;
compressing the biogas; and
passing the compressed biogas from the high pressure outlet to the digester vessel.

12. The method of claim 11 further comprising injecting the biogas near the floor of the digester.

13. The method of claim 11 further comprising increasing the flow of heated sludge in a corkscrew like flow path in the digester.

14. The method of claim 11, wherein adding a regulated amount of air comprises maintaining a ratio of biogas to air of 20:1.

15. An apparatus for reducing hydrogen sulfide in a biogas comprising:
a positive displacement device with a low pressure inlet and a high pressure outlet;
an apparatus with a first port, which is coupled to the low pressure inlet, a second port, which is coupled to the high pressure outlet, and a third port;
a gas eductor that is coupled to the third port of the apparatus;
a mass flow controller coupled to the gas eductor; and
a mass flow sensor that measures the amount of biogas produced by the digester and communicates with the mass flow controller.

16. The apparatus of claim 15, wherein the positive displacement device is a root's blower.

17. The apparatus of claim 15, wherein the gas eductor pulls in air.

18. The apparatus of claim 17, wherein the mass flow controller and mass flow sensor communicate to establish a constant ratio of biogas to air.

19. The apparatus of claim 17, wherein the apparatus further comprises an air filter coupled to the gas eductor.

20. The apparatus of claim 18, wherein the ratio of biogas to air is 20:1.
